(19) United States
(12) Patent Application Publication
(10) Pub. No.: US 2026/0268268 A1
(43) Pub. Date: Sep. 10, 2026

(54) SYSTEM

(71) Applicant: SOFTBANK GROUP CORP., Tokyo (JP)

(72) Inventor: Masami OKUZUMI, Tokyo (JP)

(73) Assignee: SOFTBANK GROUP CORP., Tokyo (JP)

(21) Appl. No.: 19/557,223

(22) Filed: Mar. 5, 2026

Related U.S. Application Data
(60) Provisional application No. 63/767,941, filed on Mar. 6, 2025.

(51) Int. Cl. G06Q 10/083; G06Q 10/02; H04L 9/40

(52) U.S. Cl. CPC G06Q 10/08355; G06Q 10/02; H04L 63/0428

(57) ABSTRACT

An information processing system using generative AI, aiming to centrally manage internal regulations, various guidelines, and equipment inventory status, and automatically respond to employee inquiries regarding legal matters, security, and equipment loan requests is provided. The system comprises a Regulations Database Section, a Guidelines Database Section, an Inventory Management Database Section, a Reception Section, an Analysis Section, a Notification Section, and a Reservation Management Section. Employees input inquiries or requests via terminals and transmit them to the server. The analysis unit uses natural language processing technology to analyze the content and determine its validity based on regulations and guidelines. The notification unit notifies the employee of necessary revisions or countermeasures based on the analysis results. The reservation management unit checks inventory status and makes a reservation if the item is available for loan. This achieves improved operational efficiency and enhanced compliance.

### CROSS-REFERENCE TO RELATED APPLICATION

This application claims priority under 35 U.S.C. § 119 to U.S. Provisional Patent Application No. 63/767,941, filed on March 6, 2025, the entire contents of which are incorporated herein by reference.

### BACKGROUND

### Technical Field

The present disclosure relates to a system.

### Related Art

Japanese Patent Application Publication Laid-Open (JP-A) No. 2022-180282 discloses a persona chatbot control method performed by at least one processor, comprising: a step of receiving a user utterance; a step of adding to the user utterance a prompt containing a description of the chatbot's persona and related instructions; a step of encoding the prompt; and a step of inputting the encoded prompt into a language model to generate a chatbot utterance in response to the user utterance.

### SUMMARY

A system and robot for improving information management and operational efficiency within a company is provided. Specifically, there is a need to comprehensively manage diverse information such as internal regulations, guidelines, and inventory status of equipment, and to respond promptly and accurately to employee inquiries regarding legal matters, security concerns, and equipment loan requests. Traditionally, these tasks were often handled manually by personnel in each department.

This approach was time-consuming for searching and verifying information, leading to reduced operational efficiency and wasted human resources. Furthermore, insufficient compliance with regulations and guidelines posed a risk of compliance issues arising.

The disclosure intends to solves these challenges by providing a system that utilizes generative AI to centrally manage internal information and automatically respond to employee inquiries and requests. The AI analyzes consultation content using natural language processing technology and determines appropriateness based on regulations and guidelines, enabling swift and accurate responses. Furthermore, by checking equipment inventory status in real time and automatically processing reservations when items are available for loan, it enhances operational efficiency and optimizes resource utilization. This allows employees to focus on more critical tasks, leading to improved overall corporate productivity and strengthened compliance.

As a means to solve the issues, an information processing system utilizing generative AI is provided. This system comprises: a regulation database section storing internal company regulations; a guideline database section storing various guidelines; an inventory management database section managing equipment inventory status; a reception unit that accepts legal consultations, security consultations, and equipment loan requests from employees; an analysis unit that analyzes the received consultations and requests, references the regulation database unit and guideline database unit to determine their validity; a notification unit that generates and notifies the requester of necessary amendments or countermeasures based on the analysis results; and a reservation management unit that references the inventory management database unit to determine the availability of equipment for loan, makes a reservation if available, and sends a pickup request to the applicant.

This system enables automatic and prompt responses to inquiries and applications from employees. Specifically, the Reception Unit accepts legal consultations, security consultations, and equipment loan requests from employees. The Analysis Unit analyzes the content using natural language processing technology and determines validity based on regulations and guidelines. The Notification Unit provides specific corrective proposals or countermeasures to the inquirer based on the analysis results and notifies them via email or the internal messaging system. For equipment loan requests, the inventory management database unit checks stock availability. If available, the reservation management unit automatically processes the reservation and sends a pickup request to the applicant. This achieves both operational efficiency and enhanced compliance.

### BRIEF DESCRIPTION OF THE DRAWING

FIG. 1 is a conceptual diagram showing an example configuration of the data processing system according to the first embodiment.

FIG. 2 is a conceptual diagram showing an example of key functions of the data processing device and smart device according to the first embodiment.

FIG. 3 is a conceptual diagram showing an example configuration of the data processing system according to the second embodiment.

FIG. 4 is a conceptual diagram showing an example of the main functions of the data processing device and smart glasses according to the second embodiment.

FIG. 5 is a conceptual diagram showing an example configuration of a data processing system according to a third embodiment.

FIG. 6 is a conceptual diagram showing an example of the main functions of the data processing device and headset-type terminal according to the third embodiment.

FIG. 7 is a conceptual diagram showing an example configuration of a data processing system according to the fourth embodiment.

FIG. 8 is a conceptual diagram showing an example of the main functions of the data processing device and robot according to the fourth embodiment.

FIG. 9 shows an emotion map onto which multiple emotions are mapped.

FIG. 10 shows an emotion map onto which multiple emotions are mapped.

### DETAILED DESCRIPTION

The following describes an example embodiment of a system according to the present disclosure with reference to the accompanying drawings.

First, the terminology used in the following description is explained.

In the following embodiments, a processor (hereinafter simply referred to as a "processor") may be a single arithmetic unit or a combination of multiple arithmetic units. Furthermore, the processor may be a single type of arithmetic unit or a combination of multiple types of arithmetic units. Examples of processing units include a CPU (Central Processing Unit), a GPU (Graphics Processing Unit), a GPGPU (General-Purpose Computing on Graphics Processing Units), an APU (Accelerated Processing Unit), and the like.

In the following embodiments, signed RAM (Random Access Memory) is a memory where information is temporarily stored and is used as working memory by the processor.

In the following embodiments, the signed storage is one or more non-volatile storage devices that store various programs and various parameters, etc. Examples of non-volatile storage devices include flash memory (SSD (Solid State Drive)), magnetic disks, (e.g., hard disk), or magnetic tape, etc.

In the following embodiments, the communication I/F (Interface) is an interface including a communication processor and an antenna, etc. The communication I/F governs communication between multiple computers. Examples of communication standards applicable to the communication I/F include wireless communication standards such as 5G (5^{th} Generation Mobile Communication System), Wi-Fi (registered trademark), or Bluetooth (registered trademark).

In the following embodiments, "A and/or B" is synonymous with "at least one of A and B." That is, "A and/or B" means it may be only A, only B, or a combination of A and B. Furthermore, in this specification, when three or more items are expressed connected by "and/or," the same concept applies as for "A and/or B".

### First Embodiment

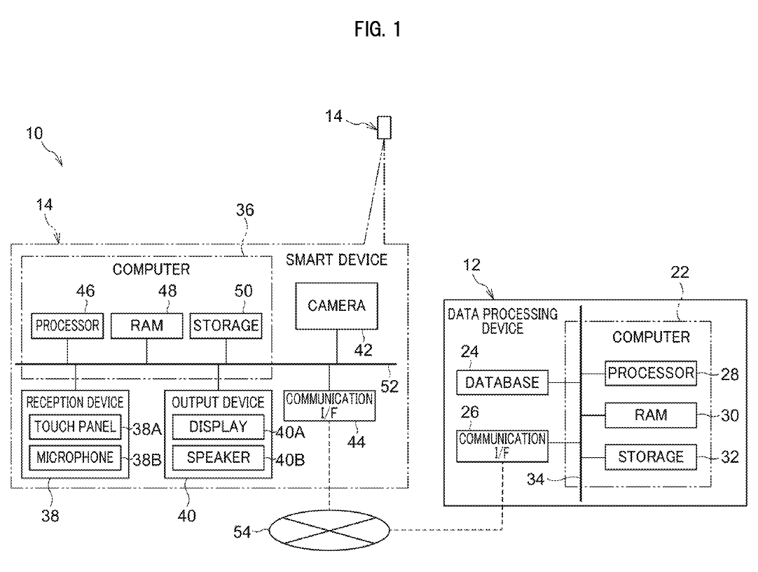

FIG. 1 shows an example configuration of a data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52.

The reception device 38 includes a touch panel 38A and a microphone 38B, among other components, and receives user input. The touch panel 38A receives user input via contact with an indicator (e.g., a pen or finger) by detecting such contact. The microphone 38B receives voice-based user input by detecting the user's voice. The control unit 46A transmits data indicating the user input received via the touch panel 38A and microphone 38B to the data processing unit 12. Within the data processing unit 12, the specific processing unit 290 acquires the data indicating the user input.

Output device 40 includes display 40A and speaker 40B, among others, and presents data to user 20 by outputting it in a form perceptible to user 20 (e.g., audio and/or text). Display 40A displays visual information such as text and images according to instructions from processor 46. Speaker 40B outputs audio according to instructions from processor 46. Camera 42 is a compact digital camera equipped with an optical system including a lens, aperture, and shutter, and an imaging element such as a CMOS (Complementary Metal-Oxide-Semiconductor) image sensor or a CCD (Charge Coupled Device) image sensor.

The communication I/F 44 is connected to the network 54. The communication I/F 44 and 26 manage the exchange of various information between processor 46 and processor 28 via network 54.

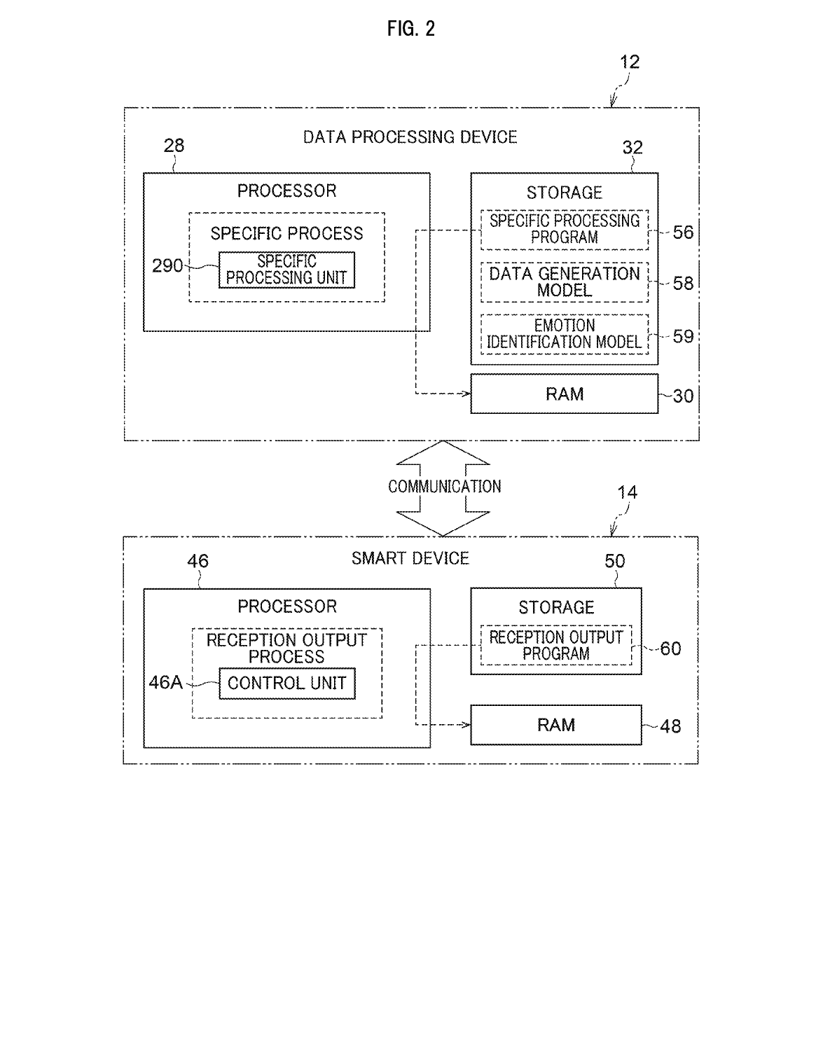

FIG. 2 shows an example of the main functions of the data processing device 12 and the smart device 14.

As shown in FIG. 2, specific processing is performed by processor 28 in data processing device 12. Specific processing program 56 is stored in storage 32. Specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

The smart device 14 performs reception output processing via the processor 46. The reception output program 60 is stored in the storage 50. The reception output program 60 is used in conjunction with the specific processing program 56 by the data processing system 10. The processor 46 reads the reception output program 60 from the storage 50 and executes the read reception output program 60 on the RAM 48. The specific processing is performed by the processor 46 operating as a control unit 46A according to the specific processing program 60 executed on the RAM 48. Note that the smart device 14 may also have data generation models and emotion identification models similar to the data generation model 58 and emotion identification model 59, and may perform processing similar to that of the specific processing unit 290 using these models. The reception output processing is realized by the processor 46 operating as the control unit 46A according to the reception output program 60 executed on the RAM 48.

Other devices besides the data processing device 12 may also have the data generation model 58. For example, a server device (e.g., a generation server) may have the data generation model 58. In this case, the data processing device 12 communicates with the server device having the data generation model 58 to obtain processing results (such as prediction results) obtained using the data generation model 58. Furthermore, the data processing device 12 may be the server device itself, or it may be a terminal device owned by a user (e.g., a mobile phone, robot, home appliance, etc.). Next, an example of processing by the data processing system 10 according to the first embodiment will be described.

### Example 1

The flow of the specific processing in Example 1 is described below. The components of the system described below are implemented by the data processing device 12 and the smart device 14. The data processing device 12 is referred to as the "server," and the smart device 14 is referred to as the "terminal."

### Implementation Examples for Carrying Out the Invention

The embodiment for implementing the present invention will now be described in further detail. This system uses generative AI to comprehensively manage internal company information and automatically respond to employee inquiries and requests. It is implemented using a server and terminals.

First, the server serves as the core of the system and implements the following components. The Regulations Database component digitizes internal company regulations and stores them as structured data. This database includes, for example, procedures for creating contracts, legal approval processes, compliance requirements, working hour management based on labor laws, and regulations concerning employee benefits. This information is stored in formats such as XML or JSON, designed to facilitate easy searching and analysis.

The Guideline Database Section stores various guidelines, including information security policies, data protection procedures, access control rules, IT asset usage guidelines, and remote work policies. These guidelines are regularly updated and maintained to comply with the latest security standards and industry norms.

The Inventory Management Database Section manages the inventory status of equipment. Information such as the quantity of each piece of equipment, its loanable status, usage history, and maintenance schedule is updated in real time and managed on the server. This includes inventory information for office equipment such as meeting room projectors, laptops, tablets, digital cameras, office chairs, and desk lamps. This enables accurate tracking of equipment usage and efficient resource management.

The Reception Section accepts legal consultations, security consultations, and equipment loan requests from employees. Employees input these consultations and requests via terminals and send them to the server. Terminals include desktop computers, laptops, tablets, and smartphones used by employees, accessible through dedicated applications or web interfaces.

The analysis unit runs on the server and analyzes the received inquiries and requests using natural language processing technology. For example, for legal inquiries, it analyzes the content and references the regulations database unit to determine validity. Specifically, it checks whether contract clauses comply with internal regulations and whether there are legal risks. Similarly, for security inquiries, it references the guidelines database unit to assess compliance and provides advice on data protection and access control.

The Notification Unit generates necessary amendments or countermeasures based on the analysis results and notifies the inquirer via their terminal. Notifications are delivered via email or the internal messaging system. For example, it provides specific instructions such as, "This part of the contract violates Article 3 of the internal regulations. As an amendment, please change it as follows." For security-related inquiries, it presents specific guidelines such as, "Please implement the following procedures for data protection."

The Reservation Management Unit checks the inventory management database to determine equipment availability. If available, it processes the reservation. Upon completion, it sends a pickup request to the applicant's terminal. For example: "Your projector reservation is complete. Pickup is available on[date]." Furthermore, if inventory is insufficient, it can present alternatives such as: "The requested equipment is currently out of stock. The following equipment is available as an alternative."

In this way, the coordinated operation of the server and terminals enables prompt and accurate responses to employee inquiries and requests. The server handles centralized information management and analysis, while the terminal functions as the interface with employees. This system enables operational efficiency and enhanced compliance, contributing to improved productivity across the entire company.

### System Configuration

The system according to this embodiment comprises a regulation database unit, a guideline database unit, an inventory management database unit, a reception unit, an analysis unit, a notification unit, and a reservation management unit.

The Regulation Database Unit digitizes internal company regulations and stores them as structured data. This unit includes procedures for drafting contracts, legal approval processes, compliance requirements, working hour management based on labor laws, and regulations concerning employee benefits. For example, it details how contract clauses should be structured and how legally required approval steps should proceed. Additionally, regulations concerning working hour management specify how employees should record their working hours and outline countermeasures when overtime occurs. Regulations concerning employee benefits provide detailed explanations of the various benefits available to employees and the procedures for applying for them.

The Guidelines Database Section stores various guidelines, including the Information Security Policy, Data Protection Procedures, Access Control Rules, IT Asset Usage Guidelines, and Remote Work Guidelines. For example, the Information Security Policy provides specific procedures for data encryption methods and setting access permissions. Data protection procedures provide detailed guidelines for handling personal information and explicitly state countermeasures in the event of a violation. Access control rules define the process for granting and revoking system access permissions. IT asset usage guidelines detail how employees should use company IT assets and outline important precautions for their use.

The Inventory Management Database Department manages the inventory status of equipment, updating in real time the quantity of each item, its loanable status, usage history, maintenance schedule, and so forth. For example, it manages the inventory status of projectors in conference rooms, constantly tracking the number of projectors available for loan. It records the usage history of laptops, tracking which employee used them and for what period. It manages digital camera maintenance schedules, notifying when periodic inspections are required. It manages the quantity of office chairs, issuing alerts when new purchases are needed.

The reception desk is the department that handles legal consultations, security consultations, and equipment loan requests from employees. Employees input these inquiries and requests via terminals and send them to the server. For example, when an employee seeks legal consultation while drafting a new contract, they input the consultation details from the terminal and send it to the regulations database section. If there are security concerns, they inquire as a security consultation to the guidelines database section. If they wish to use equipment, they send a request as an equipment loan application to the inventory management database section.

The Analysis Department runs on the server and analyzes the received consultations and requests using natural language processing technology. For example, for legal consultations, it analyzes the consultation content, references the Regulations Database Department to judge its validity, checks whether contract clauses comply with internal regulations, and proposes amendments if necessary. For security consultations, it references the guideline database to assess compliance and provides advice on data protection and access control. For equipment loan requests, it references the inventory management database to verify stock status and determine loan availability.

The Notification Unit generates necessary amendments or countermeasures for the inquirer based on the analysis results and notifies the terminal. Notifications are sent via email or the internal messaging system. For example, it provides specific instructions such as: "This part of the contract violates Article 3 of the internal regulations. As an amendment, please change it as follows." For security-related inquiries, it provides concrete guidelines such as: "To protect data, please implement the following procedures." For equipment loan requests, it sends notifications such as: "The projector reservation is complete. Pickup is available on XX date." For equipment loan requests, it sends notifications such as: "Your projector reservation is complete. Pickup is available on[date]."

The Reservation Management Department checks the inventory management database to determine equipment availability and processes reservations when items are available. Upon reservation completion, it sends a pickup request to the applicant's terminal. For example, “Your projector reservation is complete. Pickup is available on[date]." Furthermore, if inventory is insufficient, it can present alternatives such as: "The requested equipment is currently out of stock. The following alternative equipment is available."

Specific examples of prompt sentences to be fed to the generative AI when implementing the present invention include the following: "Please tell me the necessary steps for creating a new contract." "Please tell me the latest guidelines regarding data protection." "Please check the inventory status of the projector and tell me if it is available for loan." These prompt sentences function as instructions for the AI to appropriately analyze information and perform the necessary actions.

### Implementation Steps

### Step 1: Digitizing Information and Storing It in Databases

First, internal regulations, various guidelines, and inventory information for equipment are digitized and stored as structured data in their respective databases. The regulations database includes procedures for creating contracts, legal approval processes, working hour management based on labor laws, and regulations concerning employee benefits. The guidelines database includes information security policies, data protection procedures, rules regarding access control, guidelines for using IT assets, and policies concerning remote work. The inventory management database includes quantities of each item, loanable status, usage history, and maintenance schedules. This data is stored in XML or JSON formats, designed for easy search and analysis.

### Step 2: Receiving Employee Consultations and Requests

Employees input legal consultations, security consultations, and equipment loan requests via terminals and send them to the server. Terminals include desktop computers, laptops, tablets, and smartphones used by employees, accessible via dedicated applications or web interfaces. For example, when an employee seeks legal consultation while drafting a new contract, they input the consultation details from the terminal and send it to the regulations database section. If there are security concerns, they inquire as a security consultation to the guidelines database section. If they wish to use an item, they send a request as an equipment loan application to the inventory management database section.

### Step 3: Content Analysis by Generative AI

The analysis unit, running on the server, analyzes the received consultation or application content using natural language processing technology. For legal consultations, it analyzes the content, references the regulations database unit to determine validity, and checks whether contract clauses comply with internal regulations, suggesting revisions if necessary. For security consultations, it references the guidelines database unit to determine compliance and provide advice on data protection and access control. For equipment loan requests, it checks inventory status by referencing the inventory management database section to determine loan availability. Specific examples of prompt sentences fed to the generative AI include: "Please explain the necessary steps for creating a new contract," "Please provide the latest guidelines on data protection," and "Please check the inventory status of projectors and confirm if they are available for loan."

### Step 4: Notification of Analysis Results

Based on results obtained by the analysis unit, the notification unit generates necessary revisions or countermeasures for the consultant and notifies them via terminal. Notifications are sent via email or the internal messaging system. For example, it provides specific instructions such as: "This section of the contract violates Article 3 of the internal regulations. Please revise it as follows." For security-related inquiries, it presents concrete guidelines like: "Please implement the following procedures for data protection." For equipment loan requests, it sends notifications such as: "Your projector reservation is complete. Pickup is available on[date]."

### Step 5: Equipment Reservation Management

The Reservation Management Department checks the inventory database to determine equipment availability and processes reservations if available. Upon reservation completion, it sends a pickup request to the applicant's device. For example: "Your projector reservation is confirmed. Pickup is available on[date]." Furthermore, if inventory is insufficient, it can present alternatives such as: "The requested equipment is currently out of stock. The following alternative equipment is available."

### Specific Use Case

For example, consider a scenario where an employee at a company needs to create a new contract. This employee uses the system of the present invention to verify whether the contract's content complies with internal regulations. The employee inputs the contract's content as a legal consultation via a dedicated application or web interface on their terminal and sends it to the server. At this point, they use the prompt "Please tell me the necessary steps for creating a new contract" directed at the generative AI.

The analysis unit on the server analyzes the received contract content using natural language processing technology and references the regulation database unit to determine its validity. Specifically, it checks whether each clause of the contract complies with internal regulations and confirms the absence of legal risks. For example, it performs detailed analysis to verify whether payment terms in the contract comply with internal financial regulations or whether the contract period poses no legal issues.

Based on the analysis results, the notification unit generates necessary revision proposals or countermeasures for employees and notifies them via their terminals. For example, it provides specific instructions such as: "The payment terms in the contract violate Article 5 of the internal regulations. As a revision proposal, please change them as follows." This notification is delivered via email or the internal messaging system.

Consider another use case: an employee wishes to borrow a projector for a meeting. This employee requests the projector loan as an equipment loan application and sends it from their terminal to the server. At this point, they use the prompt, "Check the projector's inventory status and tell me if it is available for loan," to the generative AI.

The analysis unit on the server checks the projector's inventory status by referencing the inventory management database unit and determines whether it is available for loan. If the loan is possible, the reservation management unit makes the reservation and sends a pickup request to the employee's terminal. For example, it sends a notification stating: “Your projector reservation is complete. Pickup is available on[date]." If inventory is insufficient, it can also suggest alternatives, such as: "Projectors are currently out of stock. The following equipment is available as substitutes."

Thus, the system of the present invention can respond quickly and accurately to diverse inquiries and requests from employees, achieving operational efficiency and enhanced compliance. Other specific examples of prompt sentences to feed into the generative AI include: "Please provide the latest guidelines on data protection," or "Confirm the resources required for the new project." These prompt sentences function as instructions for the AI to appropriately analyze information and perform the necessary actions.

### Application Example 1

The flow of specific processing in Application Example 1 is described below. The components of the system described below are implemented by the data processing device 12 and the smart device 14. The data processing device 12 is referred to as the "server," and the smart device 14 is referred to as the "terminal."

### Implementation Examples for the Present Invention

A further specific and detailed description of an embodiment for implementing the present invention is provided. This embodiment is a system for realizing inventory management, automated shipping instructions, and optimized delivery routes in a logistics center, utilizing generative AI to enhance operational efficiency and accuracy.

First, inventory management will be explained in detail. The inventory database unit manages real-time information on all products within the logistics center. This unit records product quantities, storage locations, and inbound/outbound history. For example, when a product arrives at the logistics center, its information is read using a barcode scanner and registered in the inventory database. This ensures the accurate quantity and storage location of products are always known. Furthermore, when goods are shipped, the inventory database is automatically updated based on shipping instructions, maintaining accurate inventory status. Additionally, the inventory database unit manages product expiration dates and quality control information to ensure goods are shipped in a quality-assured state. For example, for goods where expiration dates are critical, such as food or pharmaceuticals, it can issue alerts as expiration dates approach and instruct priority shipping.

Next, the automation of shipping instructions is explained in detail. The Shipping Management Department generates shipping instructions based on order information. When order information is entered into the system, this department references the inventory database and creates a picking list for the required items. The picking list specifies the storage location, quantity, and shipping destination for each item, guiding workers in selecting the goods. For example, when an order from a customer is entered into the system, the Shipping Management Department instructs which items to pick, from which shelves, and in what quantities based on that order. This process streamlines shipping operations and reduces human error. Furthermore, the Shipping Management Department sets shipping priorities, enabling swift responses to urgent shipping requests. For instance, if an urgent shipment is required for a specific customer, the Shipping Management Department prioritizes processing that order and rapidly generates shipping instructions.

Furthermore, we will explain delivery route optimization in detail. The Delivery Route Optimization Department calculates the optimal delivery route based on the delivery destination address information, current traffic conditions, and the location information of the delivery vehicles. This unit calculates routes that deliver to multiple destinations via the shortest distance or fastest time and issues instructions to drivers. For example, the AI acquires real-time traffic information and proposes routes that avoid congestion. It also considers routes that minimize fuel consumption for delivery vehicles. This improves delivery efficiency and enables cost reduction. Furthermore, the delivery route optimization unit can create an optimal delivery schedule by considering the available pickup times at delivery destinations. For example, if a delivery destination can only receive packages during specific time slots, it plans a delivery route aligned with those time slots to achieve efficient delivery.

The system's processing begins when order information is entered into the system. The Shipping Management Department then references the inventory database to generate shipping instructions. Next, the Delivery Route Optimization Department calculates the optimal delivery route and issues instructions to the driver. Once shipping is complete, the inventory database is updated, maintaining accurate inventory status. This streamlines logistics center operations, enabling accurate and rapid delivery. Specific examples of prompt sentences fed to the generative AI include: "Create a picking list based on the following orders." and "Calculate the optimal delivery route considering current traffic conditions." These prompt sentences function as instructions for the AI to properly analyze information and perform necessary actions.

### System Configuration

The system according to this embodiment comprises an inventory database unit, a shipping management unit, and a delivery route optimization unit. The inventory database unit manages real-time information on all products within the logistics center. This unit records product quantities, storage locations, and inbound/outbound history. For example, when a product arrives at the logistics center, product information is read using a barcode scanner and registered in the inventory database. This ensures the accurate quantity and storage location of products are always known. Furthermore, when a product is shipped, the inventory database is automatically updated based on the shipping instructions, maintaining accurate inventory status. Furthermore, the Inventory Database Department also manages product expiration dates and quality control information to ensure goods are shipped in a quality-assured state. For example, for products where expiration dates are critical, such as food or pharmaceuticals, the system can issue alerts as expiration dates approach and instruct priority shipping. Moreover, when inventory for a specific product falls below a certain threshold, the system can automatically place replenishment orders.

The Shipping Management Department generates shipping instructions based on order information. When order information is entered into the system, this department references the inventory database to create a picking list for the required items. The picking list specifies the product storage location, quantity, and shipping destination information. Workers pick products according to this list. For example, when an order from a customer is entered into the system, the Shipping Management Department instructs which products to pick, from which shelves, and in what quantities based on that order. This process streamlines shipping operations and reduces human error. Furthermore, the Shipping Management Department sets shipping priorities, enabling swift responses to urgent shipping requests. For instance, if an urgent shipment is required for a specific customer, the department prioritizes that order and rapidly generates shipping instructions. Additionally, the department automatically generates necessary shipping documents, further enhancing shipping operation efficiency.

The Delivery Route Optimization Department calculates the optimal delivery route based on destination address information, current traffic conditions, and delivery vehicle location data. This department calculates routes that enable delivery via the shortest distance or in the shortest time, even when multiple destinations exist, and issues instructions to drivers. For example, AI acquires real-time traffic information and proposes routes that avoid congestion. It also considers routes that minimize fuel consumption for delivery vehicles. This improves delivery efficiency and enables cost reduction. Furthermore, the Delivery Route Optimization Unit can create optimal delivery schedules considering the available pickup times at delivery destinations. For instance, if a delivery destination can only receive packages during specific hours, it plans routes aligned with those hours to achieve efficient delivery. Furthermore, the route optimization unit can incorporate weather information and select safe routes during inclement weather.

Specific examples of prompt sentences to be fed to the generative AI when implementing the present invention include: "Create a picking list based on the following orders," "Calculate the optimal delivery route considering current traffic conditions," and "Automatically place orders when inventory of specific items becomes low." These prompt sentences function as instructions for the AI to appropriately analyze information and perform necessary actions.

### Implementation Steps

### Step 1: Registering Inventory Information

When goods arrive at the logistics center, product information is scanned using a barcode scanner and registered in the inventory database. This step accurately records the quantity of goods, storage location, and inbound/outbound history. For goods where expiration dates are critical, such as food or pharmaceuticals, the expiration date is also registered simultaneously to ensure thorough quality control. Furthermore, when the inventory of a specific product falls below a certain threshold, an alert can be triggered, and an order for replenishment can be placed automatically.

### Step 2: Entering Order Information

When a customer order is entered into the system, the Shipping Management Department receives the information, references the inventory database, and generates shipping instructions. In this step, a picking list for the required items is created based on the order information, and detailed instructions including the item's storage location, quantity, and shipping destination information are provided to the operator. For example, if there is an urgent shipping request, the Shipping Management Department prioritizes processing that order and generates shipping instructions promptly.

### Step 3: Picking List Generation

The Shipping Management Department generates a picking list based on the order information. This list specifies the product storage location, quantity, and shipping destination information, and workers pick the products according to it. For example, if an urgent shipment is required for a specific customer, the Shipping Management Department prioritizes processing that order and quickly generates shipping instructions. Furthermore, the Shipping Management Department also automatically generates the necessary documents at the time of shipment, further improving the efficiency of the shipping operation.

### Step 4: Delivery Route Optimization

The Delivery Route Optimization Department calculates the optimal delivery route based on the delivery destination addresses, current traffic conditions, and the location information of the delivery vehicles. In this step, even when multiple delivery destinations exist, it calculates the route that can deliver via the shortest distance or in the shortest time and issues instructions to the driver. An example prompt for the generative AI could be: "Calculate the optimal delivery route considering current traffic conditions." Furthermore, the Delivery Route Optimization Unit can incorporate weather information, enabling it to select safer routes during inclement weather.

### Step 5: Inventory Data Update

Upon shipment completion, the inventory database is automatically updated to maintain accurate stock levels. This step records goods outbound information and reduces inventory quantities. Additionally, product expiration dates and quality control information are updated, ensuring quality is maintained for the next shipment. For example, if inventory falls below a certain threshold after shipment, an alert can be triggered, and a replenishment order can be automatically placed.

### Specific Use Cases

For example, the system of the present invention is utilized at a logistics center during large-scale food arrivals. At this center, managing food expiration dates is critical. Upon arrival, product information is read using barcode scanners and registered in the inventory database. This process accurately records the product quantity, storage location, and expiration date. As the expiration date approaches, the system can automatically issue alerts and instruct priority shipping. This minimizes waste due to expired products.

Next, when customer orders are entered into the system, the Shipping Management Department receives this information, references the inventory database, and generates shipping instructions. At this stage, a picking list for the required items is created based on the order information, and detailed instructions—including the item's storage location, quantity, and shipping destination—are provided to the workers. For example, if an urgent shipment request occurs, the Shipping Management Department prioritizes processing that order and rapidly generates the shipping instructions. This streamlines shipping operations and reduces human error.

Furthermore, the Delivery Route Optimization Department calculates the optimal delivery route based on the delivery destination address information, current traffic conditions, and the location information of the delivery vehicles. In this step, even when there are multiple delivery destinations, it calculates the route that can deliver in the shortest distance or shortest time and issues instructions to the driver. An example prompt for the generative AI could be: "Calculate the optimal delivery route considering current traffic conditions." Furthermore, the Delivery Route Optimization Unit can incorporate weather information, enabling it to select safer routes during inclement weather.

Upon shipment completion, the inventory database is automatically updated to maintain accurate stock levels. This process records goods outbound information and reduces inventory quantities. Additionally, product expiration dates and quality control information are updated, ensuring quality is maintained for the next shipment. For example, if inventory falls below a certain threshold after shipment, an alert can be triggered, and a replenishment order can be automatically placed. This streamlines logistics center operations, enabling accurate and rapid delivery.

The specific processing unit 290 transmits the results of the specific processing to the smart device 14. On the smart device 14, the control unit 46A instructs the output device 40 to output the results of the specific processing. The microphone 38B acquires audio indicating user input regarding the results of the specific processing. The control unit 46A transmits the audio data indicating the user input acquired by the microphone 38B to the data processing unit 12. At the data processing unit 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 may include, for example, text generation AI, image generation AI, multimodal generation AI, etc. Here, inference refers to, for example, analysis, classification, prediction, and/or summarization. The specific processing unit 290 performs the aforementioned specific processing while using the data generation model 58. The data generation model 58 may be a model fine-tuned to output inference results from prompts that do not include instructions. In this case, the data generation model 58 can output inference results from prompts that do not contain instructions. In this case, the data generation model 58 can output inference results from prompts that do not contain instructions. The data processing device 12, etc., includes multiple types of data generation models 58, and the data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. The AI may also be an AI agent. Furthermore, when the processing of the aforementioned components is performed by the AI, such processing may be performed in part or in whole by the AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart device 14.

### Second Embodiment

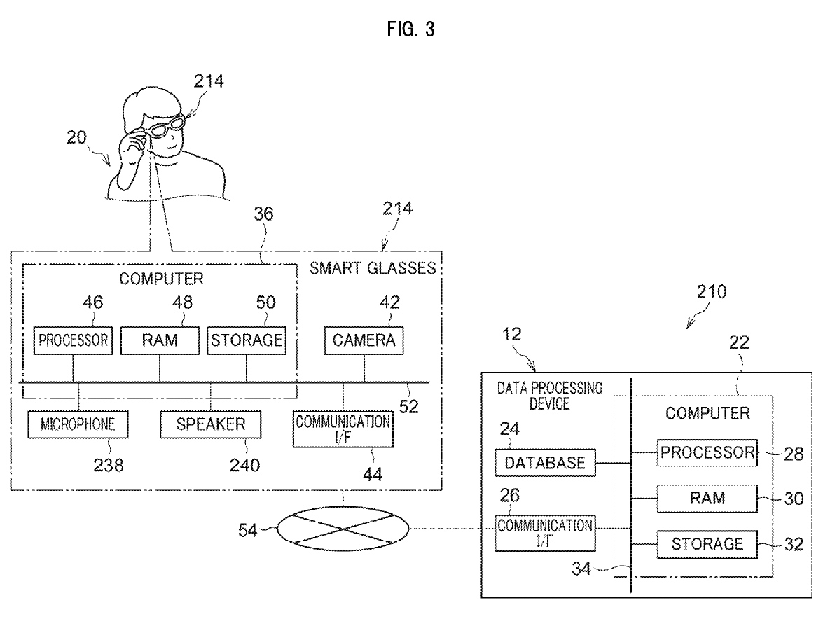

FIG. 3 shows an example configuration of the data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. Examples of the network 54 include a WAN (Wide Area Network) and/or a LAN (Local Area Network).

Smart glasses 214 include a computer 36, a microphone 238, a speaker 240, a camera 42, and a communication I/F 44. The computer 36 includes a processor 46, RAM 48, and storage 50. Processor 46, RAM 48, and storage 50 are connected to bus 52. Microphone 238, speaker 240, and camera 42 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

Camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

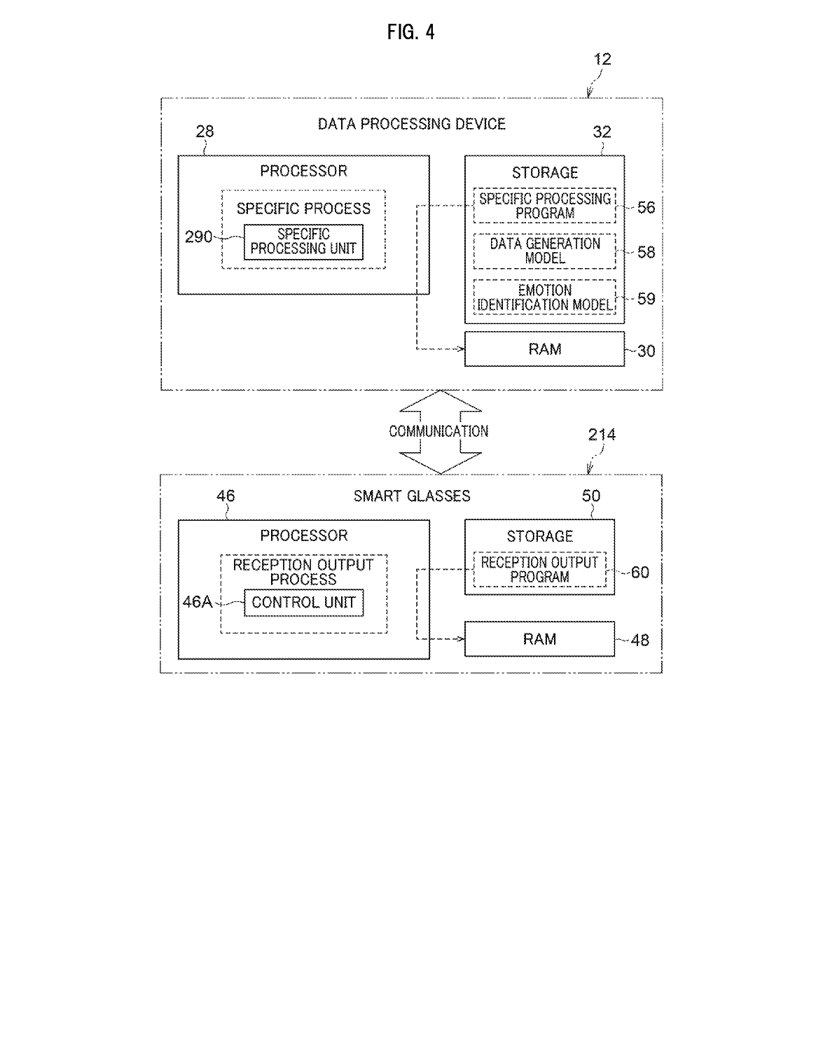

FIG. 4 shows an example of key functions of the data processing device 12 and the smart glasses 214. As shown in FIG. 4, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion includes, for example, analysis (parsing) of emotion.

In the smart glasses 214, the processor 46 performs the reception output processing. The reception output program 60 is stored in the storage 50. The processor 46 reads the reception output program 60 from the storage 50 and executes the read reception output program 60 on the RAM 48. The reception output processing is realized by the processor 46 operating as the control unit 46A according to the reception output program 60 executed on the RAM 48. The reception output processing is performed by the processor 46 acting as a control unit 46A according to the reception output program 60 executed on RAM 48. Note that the smart glasses 214 may also have a data generation model 58 and an emotion identification model 59, and can perform processing similar to that of the identification processing unit 290 using these models.

Next, the identification processing performed by the identification processing unit 290 of the data processing device 12 is described. The components of the system described below are implemented by the data processing device 12 and the smart glasses 214. In the following description, the data processing device 12 is referred to as the "server," and the smart glasses 214 are referred to as the "terminal."

### Example 1

The flow of the specific processing is the same as that described in Example 1 of the first embodiment, so the explanation is omitted.

### Application Example 1

The flow of the specific processing in Example 1 described in the first embodiment is the same as above, so the explanation is omitted.

The specific processing unit 290 transmits the result of the specific processing to the smart glasses 214. In the smart glasses 214, the control unit 46A causes the speaker 240 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. The AI may also be an AI agent. Furthermore, when the processing of the aforementioned components is performed by the AI, such processing may be performed in part or in whole by the AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart glasses 214.

### Third Embodiment

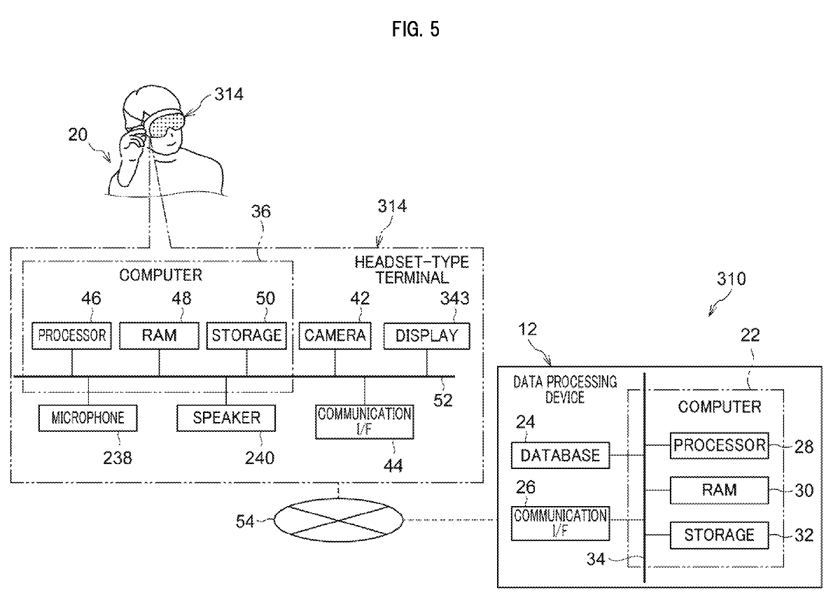

FIG. 5 shows an example configuration of the data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The headset-type terminal 314 comprises a computer 36, a microphone 238, a speaker 240, a camera 42, a communication interface 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

Microphone 238 receives voice input from user 20 to accept instructions or other commands. Microphone 238 captures the voice input from user 20, converts the captured voice into audio data, and outputs it to processor 46. Speaker 240 outputs audio according to instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

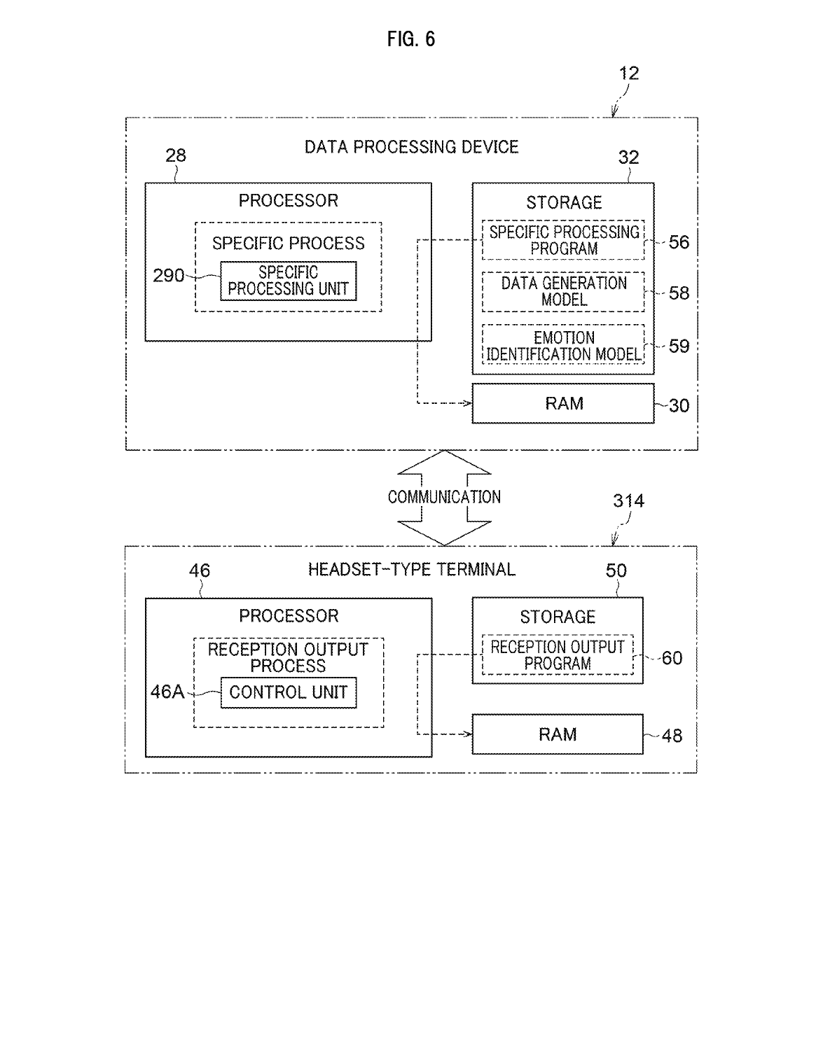

FIG. 6 shows an example of the main functions of the data processing device 12 and the headset-type terminal 314. As shown in FIG. 6, specific processing is performed by the processor 28 in the data processing device 12. The specific processing program 56 is stored in the storage 32.

The specific processing program 56 is an example of a "program" pertaining to the technology of this disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executed on the RAM 30.

Storage 32 stores a data generation model 58 and an emotion identification model 59. The data generation model 58 and the emotion identification model 59 are used by the specific processing unit 290.

In the headset-type terminal 314, reception output processing is performed by the processor 46. The reception output program 60 is stored in the storage 50. Processor 46 reads the reception output program 60 from storage 50 and executes the read reception output program 60 on RAM 48. Reception output processing is achieved by processor 46 operating as control unit 46A according to the reception output program 60 executed on RAM 48.

Next, the specific processing performed by the specific processing unit 290 of the data processing device 12 is described. The various parts of the system described below are implemented by the data processing device 12 and the headset-type terminal 314. In the following description, the data processing device 12 is referred to as the "server," and the headset-type terminal 314 is referred to as the "terminal."

### Example 1

The flow of the specific processing is the same as that described in Example 1 of the first embodiment, so the description is omitted.

### Application Example 1

The flow of the specific processing in Example 1 described in the above first embodiment is the same, so the explanation is omitted.

The specific processing unit 290 transmits the result of the specific processing to the headset-type terminal 314. At the headset-type terminal 314, the control unit 46A causes the speaker 240 and the display 343 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed partially or entirely by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., while the smart device 14 acquires or collects information necessary for processing from the data processing device 12 or external devices, etc.

For example, the collection unit is implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit may be implemented by the specific processing unit 290 of the data processing device 12 and analyze data from the collection unit and acquisition unit. For example, the generation unit may be implemented by the specific processing unit 290 of the data processing device 12 and generate a cooking menu using the generation AI. For example, the provision unit may be implemented by the output device 40 of the smart device 14 or the specific processing unit 290 of the data processing device 12 and provide the generated cooking menu. The correspondence between each unit and the device or control unit is not limited to the examples described above and can be modified in various ways.

The above embodiment described a form where specific processing is performed by the data processing device 12, but the technology disclosed herein is not limited thereto; specific processing may also be performed by the headset-type terminal 314.

### Fourth Embodiment

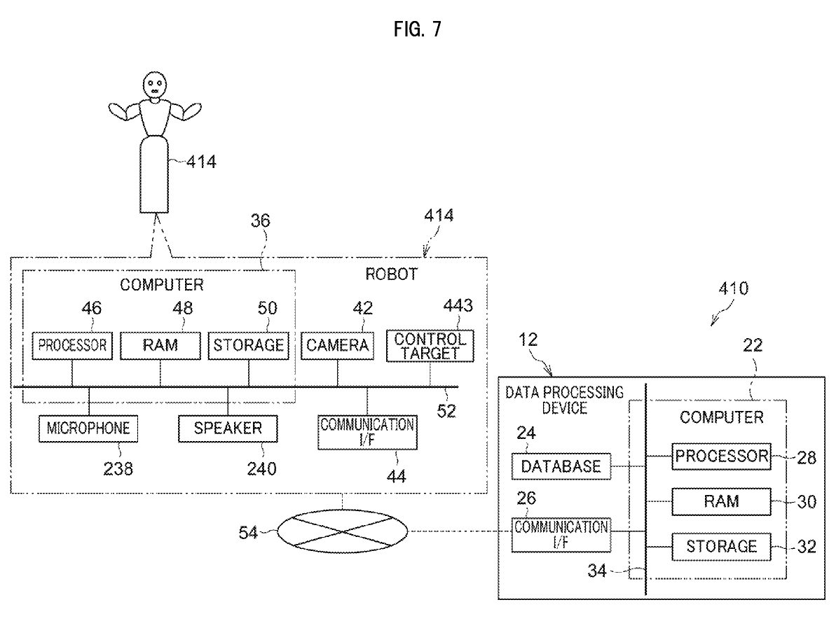

FIG. 7 shows an example configuration of the data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 is an example of a "computer" related to the technology of this disclosure. The computer 22 includes a processor 28, RAM 30, and storage processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

Robot 414 includes a computer 36, a microphone 238, a speaker 240, a camera 42, a communication I/F 44, and a control target 443. Computer 36 includes a processor 46, RAM 48, and storage 50. Processor 46, RAM 48, and storage 50 are connected to bus 52. Furthermore, microphone 238, speaker 240, camera 42, and controlled object 443 are also connected to bus 52.

The microphone 238 receives voice commands from the user 20 by capturing the user's spoken voice. The microphone 238 captures the voice emitted by the user 20, converts the captured voice into audio data, and outputs it to the processor 46. The speaker 240 outputs audio in accordance with instructions from the processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

The control target 443 includes a display device, LEDs for the eyes, and motors for driving the arms, hands, legs, etc. The posture and gestures of robot 414 are controlled by controlling the motors for the arms, hands, legs, etc. Some of the emotions of robot 414 can be expressed by controlling these motors. Furthermore, the robot's facial expressions can be expressed by controlling the light emission state of the LEDs in the robot's eyes.

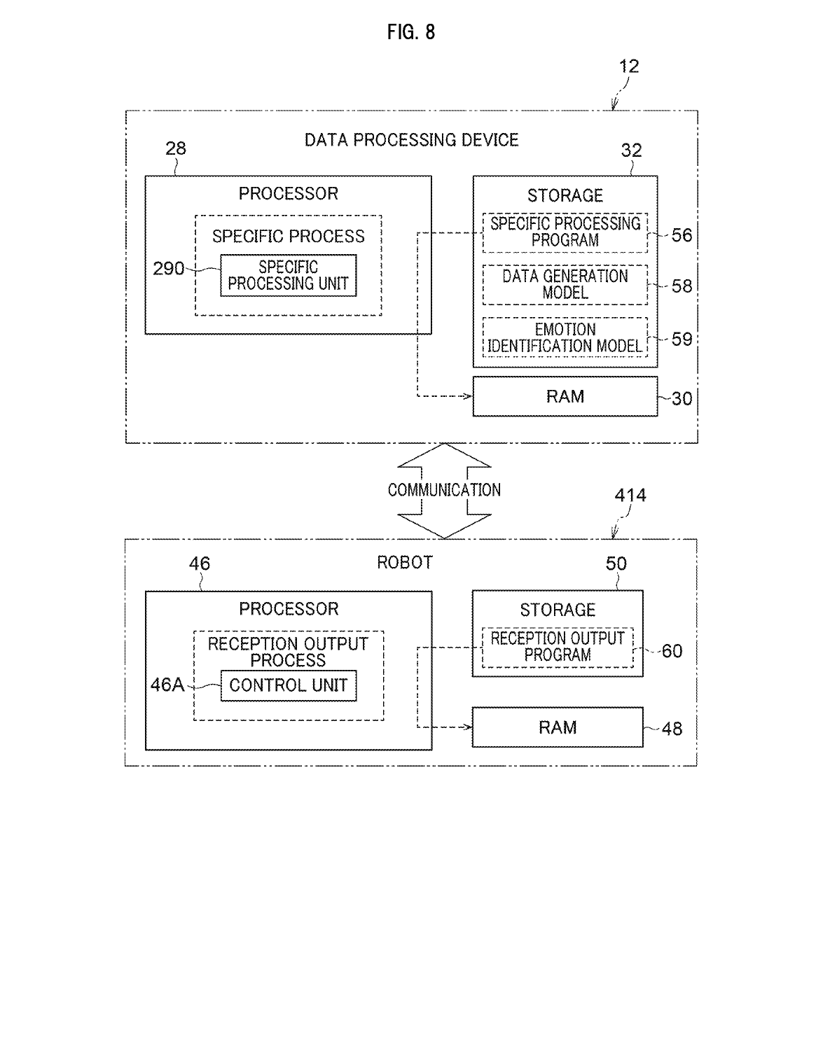

FIG. 8 shows an example of the main functions of the data processing device 12 and the robot 414. As shown in FIG. 8, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by specific processing unit 290.

In robot 414, reception output processing is performed by processor 46. Storage 50 stores a reception output program 60. Processor 46 reads the reception output program 60 from memory location 50 and executes the read reception output program 60 in RAM 48. The reception output processing is realized by the processor 46 operating as the control unit 46A according to the reception output program 60 executed in RAM 48.

Next, the specific processing performed by the specific processing unit 290 of the data processing device 12 is described. The various parts of the system described below are implemented by the data processing device 12 and the robot 414. In the following description, the data processing device 12 is referred to as the "server," and the robot 414 is referred to as the "terminal."

### Example 1

The flow of the specific processing is the same as that described in Example 1 of the first embodiment, so the explanation is omitted.

### Application Example 1

The flow of the specific processing in Example 1 described in the above first embodiment is the same, so the explanation is omitted.

The specific processing unit 290 transmits the result of the specific processing to the robot 414. In the robot 414, the control unit 46A causes the speaker 240 and the control target 443 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. A prompt containing instructions is input to the data generation model 58, and inference data such as audio data (e.g., data of still images or data of videos) is input. The data generation model 58 performs inference on the input inference data according to instructions indicated by the prompt and outputs inference results. The data generation model 58 infers based on the input inference data according to the instructions indicated by the prompt and outputs the inference result in one or more data formats such as audio data, text data, and image data. The data generation model 58 may include, for example, text generation AI, image generation AI, multimodal generation AI, etc. Here, inference refers to, for example, analysis, classification, prediction, and/or summarization. The specific processing unit 290 performs the specific processing described above using the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the robot 414.

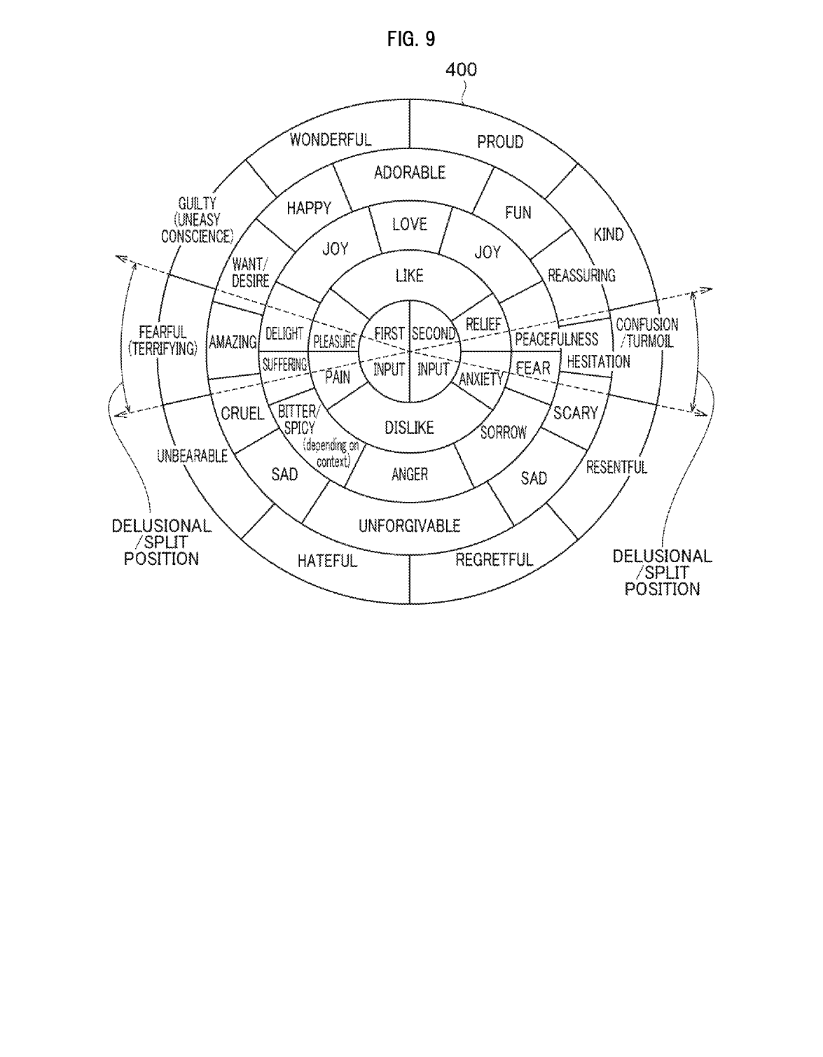

The emotion identification model 59, functioning as an emotion engine, may determine the user's emotion according to a specific mapping. Specifically, the emotion identification model 59 may determine the user's emotion according to an emotion map (see FIG. 9), which is a specific mapping. Furthermore, the emotion identification model 59 may similarly determine the robot's emotion, and the specific processing unit 290 may perform specific processing using the robot's emotion.

FIG. 9 is a diagram showing an emotion map 400 where multiple emotions are mapped. In the emotion map 400, emotions are arranged in concentric circles radiating from the center. Emotions closer to the center of the concentric circles represent more primitive states. Emotions representing states or behaviors arising from mental states are placed further out in the concentric circles. Emotion is a concept that includes affect and mental states. On the left side of the concentric circles are generally emotions generated from reactions occurring within the brain. On the right side are generally emotions induced by situational judgment. Above and below the concentric circles are generally emotions generated from reactions occurring within the brain and also induced by situational judgment. Furthermore, the upper part of the concentric circle contains "pleasant" emotions, while the lower part contains "unpleasant" emotions. Thus, the Emotion Map 400 maps multiple emotions based on the structure of their origin, with emotions that tend to occur simultaneously mapped close together.

These emotions are distributed around the 3 o'clock position on Emotion Map 400, typically oscillating between feelings of security and anxiety. In the right half of Emotion Map 400, situational awareness takes precedence over internal sensations, resulting in a calmer impression.

The inner part of the emotion map 400 represents the mind, while the outer part represents behavior. Therefore, the further out on the emotion map 400, the more visible the emotion becomes (manifesting in behavior).

Here, human emotions are based on various balances, such as posture and blood sugar levels. When these balances deviate from the ideal, it indicates a state of discomfort; when they approach the ideal, it indicates a state of comfort. Similarly, for robots, automobiles, motorcycles, etc., emotions can be created based on various balances, such as posture and battery level. When these balances deviate from the ideal, it indicates a state of discomfort; when they approach the ideal, it indicates a state of comfort. Emotion maps, for example, Dr. Mitsuyoshi's Emotion Map (Research on Speech Emotion Recognition and Neurophysiological Signal Analysis of Emotions, Tokushima University, Doctoral Dissertation: https://ci.nii.ac.jp/naid/500000375379). The left half of the emotion map displays emotions belonging to the "Reaction" area, where sensory input dominates. The right half of the emotion map displays emotions belonging to the "Situation" domain, where situational awareness is dominant.

The emotion map defines two emotions that promote learning. One is the negative emotion around the center of the "repentance" or "reflection" area on the situation side. That is, when the robot experiences negative emotions like "I never want to feel this way again" or "I don't want to be scolded anymore. “The other is the positive emotion around "desire" on the reaction side. That is, when the robot feels positive emotions like "I want more" or "I want to know more."

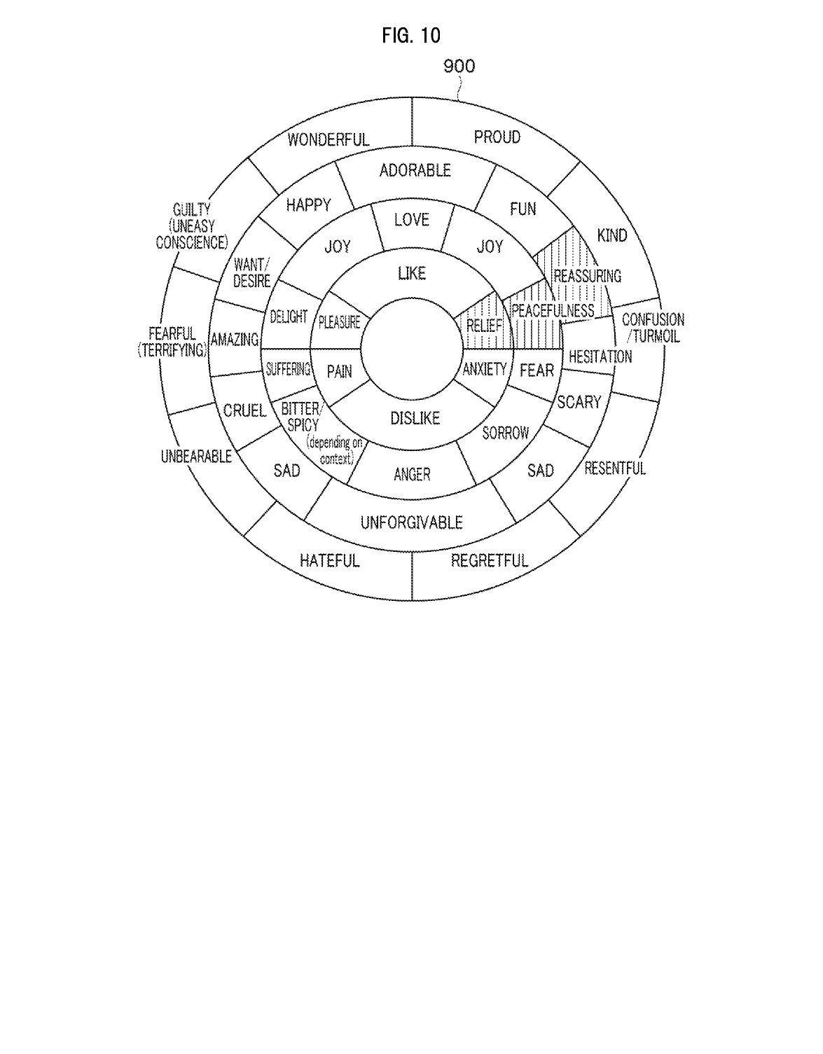

The emotion identification model 59 inputs the user input into a pre-trained neural network, obtains emotion values representing each emotion shown in the emotion map 400, and determines the user's emotion. This neural network is pre-trained based on multiple training data sets, which are combinations of user input and emotion values representing each emotion shown in the emotion map 400. Furthermore, this neural network is trained such that emotions positioned close to each other, as shown in the emotion map 900 in FIG. 10, have similar values. FIG. 10 illustrates an example where multiple emotions, such as "reassurance," "tranquility," and "encouragement," have similar emotion values.

The above description primarily explains the system of the present disclosure in terms of the functions of the data processing device 12. However, the system of the present disclosure is not necessarily implemented on a server. The system of the present disclosure may be implemented as a general information processing system. For example, the present disclosure may be implemented as a software program operating on a personal computer or as an application operating on a smartphone, etc. The method of the present disclosure may be provided to users in a SaaS (Software as a Service) format.

The above embodiments illustrated a configuration where specific processing is performed by a single computer 22. However, the technology of this disclosure is not limited thereto. Distributed processing may be performed by multiple computers, including computer 22, for specific processing. For example, data generation model 58 may be provided in an external device of data processing device 12, and said external device may generate data corresponding to input data.

The above embodiment described a configuration where a specific processing program 56 is stored in storage 32, but the technology disclosed herein is not limited thereto. For example, the specific processing program 56 may be stored on a portable, computer-readable non-volatile storage medium such as a USB (Universal Serial Bus) memory. The specific processing program 56 stored on the non-volatile storage medium is installed on the computer 22 of the data processing device 12. The processor 28 executes specific processing according to the specific processing program 56.

Alternatively, the specific processing program 56 may be stored on a storage device, such as a server, connected to the data processing device 12 via the network 54. Upon request from the data processing device 12, the specific processing program 56 is downloaded and installed on the computer 22.

It should be noted that it is not necessary to store the entire specific processing program 56 in a storage device such as a server connected to the data processing device 12 via the network 54, or to store the entire specific processing program 56 in the storage 32. It is also possible to store only a portion of the specific processing program 56.

Various types of processors can be used as hardware resources to execute the specific processing. Examples of processors include a CPU, which is a general-purpose processor that functions as a hardware resource for executing specific processing by executing software, i.e., a program. Additionally, processors may include dedicated electronic circuits, such as FPGAs (Field-Programmable Gate Array), PLDs (Programmable Logic Device), or ASICs (Application Specific Integrated Circuit), which are processors with circuit configurations specifically designed to execute particular processing. Each processor has memory either built-in or connected, and each processor executes specific processing by using this memory.

The hardware resources for executing specific processing may be comprised of one of these various processors, or may be comprised of a combination of two or more processors of the same or different types (e.g., a combination of multiple FPGAs, or a combination of a CPU and an FPGA). Furthermore, the hardware resources for executing specific processing may be a single processor.

Examples of configurations using a single processor include: First, a configuration where one processor is formed by combining one or more CPUs with software, with this processor functioning as the hardware resource executing the specific processing. Second, there is a form using a processor that implements the entire system functionality, including multiple hardware resources executing specific processing, on a single IC chip, as exemplified by a System-on-a-chip (SoC). Thus, specific processing is implemented as a hardware resource using one or more of the various processors described above.

Furthermore, regarding the hardware structure of these various processors, more specifically, electrical circuits combining circuit elements such as semiconductor devices can be employed. Moreover, the specific processing described above is merely one example. Therefore, it goes without saying that within the scope of not deviating from the main purpose, unnecessary steps may be omitted, new steps may be added, and the processing order may be changed.

The above description and illustrations provide a detailed explanation of the aspects pertaining to the technology of the present disclosure and represent merely one example of the technology disclosed herein. For example, the above descriptions of configurations, functions, operations, and effects are merely examples of configurations, functions, operations, and effects pertaining to the technical aspects of the present disclosure. Therefore, it goes without saying that within the scope not deviating from the spirit of the present disclosure's technology, unnecessary portions may be omitted, new elements added, or replacements made to the above-described content and illustrated content. Furthermore, to avoid complexity and facilitate understanding of the technical aspects of the present disclosure, descriptions of common technical knowledge and the like that are not particularly necessary for enabling the present disclosure to have been omitted from the above descriptions and illustrations.

All literature, patent applications, and technical specifications cited herein are incorporated by reference to the same extent as if each were specifically and individually cited herein.

The following further discloses the above embodiments.

### Supplementary Note 1

A logistics management system comprising an inventory database unit, a shipping management unit, and a delivery route optimization unit, wherein the inventory database unit manages in real time the quantity, storage location, and inbound/outbound history of each product within a logistics center; the shipping management unit generates shipping instructions based on order information and creates picking lists; and the delivery route optimization unit calculates the optimal delivery route based on the delivery destination address information, traffic conditions, and the location information of the delivery vehicle.

The system according to Supplementary Note 1, wherein the Shipping Management Department, upon receiving order information input into the system, references the Inventory Database Department to create a picking list for the required products and provides detailed instructions to workers containing the product storage location, quantity, and shipping destination information. This streamlines shipping operations, reduces human error, and enables swift execution of logistics center tasks.

The delivery route optimization unit acquires real-time traffic information and calculates the route enabling delivery via the shortest distance or shortest time, even when multiple delivery destinations exist, issuing instructions to the driver. This improves delivery efficiency, minimizes fuel consumption, and enables cost reduction.

### EXPLANATION OF SYMBOLS

10, 210, 310, 410 Data Processing System

12 Data Processing Device

14 Smart Device

214 Smart Glasses

314 Headset-type devices

414 Robot

What is claimed is:

1. An information processing system, comprising:
a data processing device including:
a computer comprising at least one processor including a CPU and/or GPU connected to a RAM and a non-volatile storage via a bus;
a database connected to the bus;
a communication interface including a communication processor and antenna configured to communicate via a WAN and/or LAN in an encrypted state;
a terminal device including:
a processor connected to RAM and storage via a bus;
a reception device including at least a touch panel and a microphone configured to acquire text input and audio input from a user;
an output device including at least a display and a speaker; and
a communication interface configured to securely communicate with the data processing device;
wherein the non-volatile storage of the data processing device stores:
a specific processing program;
a data generation model comprising a neural network trained by deep learning; and
an emotion identification model trained to output emotion values corresponding to multiple emotions arranged on a concentric emotion map including a reaction domain and a situation domain;
wherein the processor executes the specific processing program to operate as a specific processing unit configured to:
receive consultation data or equipment loan request data from the terminal device;
convert the received data into structured query data conforming to a predefined schema;
input a prompt including instructions and the structured query data into the data generation model;
perform natural language analysis and clause-level parsing of the consultation data;
cross-reference parsed clauses with a regulation database storing internal regulations in XML or JSON format including article identifiers and compliance procedures;
identify non-compliant clauses including corresponding regulation article identifiers;
generate amendment data including proposed revision text;
when the received data is an equipment loan request, query an inventory management database storing equipment identifier, quantity, loanable status, usage history, maintenance schedule, and reservation status updated in real time;
automatically register reservation data and update the reservation status when equipment is available; and
transmit notification data including amendment data or reservation confirmation data to the terminal device.

2. The system of claim 1, wherein the specific processing unit further inputs user audio data into the emotion identification model to obtain emotion values mapped on the concentric emotion map and modifies generated notification data based on the emotion values.

3. The system of claim 1, wherein emotions positioned close to each other on the concentric emotion map are trained to have similar output values in the emotion identification model.

4. The system of claim 1, wherein the regulation database further stores procedures for contract drafting, approval workflows, working hour management rules, and employee benefit regulations as structured searchable fields.

5. The system of claim 1, wherein the communication between the data processing device and the terminal device is performed in a secure state via encrypted transmission.

6. The system of claim 1, wherein the specific processing program is executable in a distributed processing configuration across multiple processors or multiple computers connected via the network.

7. A logistics management system, comprising:
a data processing device including:
at least one processor including a CPU and/or GPU;
RAM and non-volatile storage connected via a bus;
a communication interface configured for secure network communication; and
an inventory database storing structured records including product identifier, quantity, storage location, inbound history, outbound history, expiration date, quality control information, and replenishment threshold value;
wherein the processor executes a shipping management program and a delivery route optimization program to:
register product information read via a barcode scanner upon arrival of goods and store the product identifier, quantity, storage location, and expiration date in the inventory database;
receive order information including destination address and urgency information;
generate a picking list specifying product identifier, storage location, quantity, and shipping destination;
prioritize order processing based on urgency information;
update outbound history and reduce inventory quantity upon shipment completion;
compare the inventory quantity with the replenishment threshold value and automatically generate replenishment order data when the threshold is crossed;
acquire real-time traffic information, weather information, and delivery vehicle location data;
compute an optimized delivery route for multiple destinations using a cost function minimizing travel time, travel distance, and fuel consumption while satisfying delivery time windows; and
transmit route instruction data to a driver terminal.

8. The system of claim 7, wherein the processor generates expiration alerts when the expiration date approaches a predefined period and instructs priority shipment.

9. The system of claim 7, wherein the delivery route optimization program dynamically recalculates the optimized route upon receiving updated traffic information.

10. The system of claim 7, wherein the cost function includes weighted coefficients for congestion level, travel time, fuel consumption, and delivery time window constraints.

11. The system of claim 7, wherein the processor automatically generates shipping documents based on the picking list.

12. The system of claim 7, wherein the processor automatically transmits replenishment order data to a supplier system when inventory falls below the replenishment threshold.

13. A non-transitory computer-readable storage medium storing a specific processing program that, when executed by at least one processor including a CPU and/or GPU of a data processing device connected via a bus to RAM and non-volatile storage, causes the processor to:
receive product information scanned by a barcode scanner;
register structured product data including expiration date and replenishment threshold value in an inventory database;
receive order information including destination address and urgency information;
generate a structured picking list including product identifier, storage location, quantity, and shipping destination;
update outbound history and reduce inventory quantity upon shipment completion;
determine whether the updated inventory quantity falls below the replenishment threshold value and automatically generate replenishment order data;
acquire real-time traffic data, weather data, and delivery vehicle position data;
compute an optimized delivery route using a multi-factor cost function including travel time, congestion level, fuel consumption, and delivery time window constraints; and
output route instruction data to a terminal device.

14. The non-transitory computer-readable storage medium of claim 13, wherein the program further causes dynamic recalculation of the optimized delivery route when traffic conditions change.

15. The non-transitory computer-readable storage medium of claim 13, wherein the program further causes generation of expiration alerts when expiration dates approach a predefined threshold period.

16. The non-transitory computer-readable storage medium of claim 13, wherein the program further causes automatic generation and transmission of replenishment order data to an external supplier system.

17. The non-transitory computer-readable storage medium of claim 13, wherein execution of the program is performed in a distributed processing configuration including multiple processors connected via a network.

18. The non-transitory computer-readable storage medium of claim 13, wherein the inventory database maintains quality control information updated upon shipment completion.
